(19) United States
(12) Patent Application Publication
(10) Pub. No.: US 2024/0186569 A1
(43) Pub. Date: Jun. 6, 2024

(54) ALL SOLID-STATE BATTERY

(71) Applicant: SAMSUNG SDI CO., LTD., Yongin-si (KR)

(72) Inventors: Jinhoon YANG, Yongin-si (KR); Jungho LEE, Yongin-si (KR); Juhee SOHN, Yongin-si (KR); Hyuksoo SHIN, Yongin-si (KR); Kang Hee LEE, Yongin-si (KR); Sungwon JUNG, Yongin-si (KR)

(21) Appl. No.: 18/380,778

(22) Filed: Oct. 17, 2023

(30) Foreign Application Priority Data
Oct. 24, 2022 (KR) 10-2022-0137576

(51) Int. Cl. H01M 10/0562; H01M 4/131; H01M 4/36

(52) U.S. Cl. CPC H01M 10/0562; H01M 4/131; H01M 4/366; H01M 2300/0071

(57) ABSTRACT

Disclosed is an all solid-state battery, and the all solid-state battery including a positive electrode including a positive active material layer including a positive active material, a negative catalyst layer including a negative catalyst and Nb₂O₅; and an electrolyte, wherein an amount of Nb₂O₅ is about 1 wt % to about 30 wt % of the total, 100 wt % of the negative catalyst layer, and a ratio (N/P) of a capacity of the negative catalyst layer relative to a capacity of the positive electrode is about 0.1 or more and less than 0.5.

### CROSS-REFERENCE TO RELATED APPLICATION

This application claims priority to and the benefit of Korean Patent Application No. 10-2022-0137576 filed in the Korean Intellectual Property Office on Oct. 24, 2022, the entire contents of which are incorporated herein by reference.

### BACKGROUND

### 1. Field

Embodiments relate to all solid-state battery.

### 2. Description of the Related Art

Recently, with the rapid spread of electronic devices such as mobile phones, laptop computers, and electric vehicles using batteries, the demand for small, lightweight, and relatively high-capacity rechargeable batteries is rapidly increasing. Particularly, a rechargeable lithium battery has recently drawn attention as a driving power source for portable devices, as it has lighter weight and high energy density. Thus, research for improving performances of rechargeable lithium is being actively studied.

Among rechargeable lithium batteries, the term “all solid-state battery” refers to a battery in which all materials are solid. In some embodiments, the all solid-state battery may be a battery using a solid electrolyte. The solid electrolyte may be positioned between the positive electrode and the negative electrode, thereby preventing direct contact between the positive electrode and the negative electrode. Simultaneously, the solid electrolyte may serve as a passage for the movement of lithium ions during charge and discharge.

### SUMMARY

Embodiments may provide an all solid-state battery including a positive active material layer that includes a positive active material, a negative electrode including a negative catalyst layer a negative catalyst, Nb₂O₅; and an electrolyte, wherein an amount of Nb₂O₅ is about 1 wt % to about 30 wt % based on the total, 100 wt % of the negative catalyst layer and a ratio (N/P) of capacity of the negative catalyst layer relative to capacity of the positive electrode is about 0.1 or more and less than about 0.5.

The amount of Nb₂O₅ may be about 3 wt % to about 30 wt % or about 5 wt % to about 15 wt % based on the total, 100 wt % of the negative catalyst layer.

The ratio (N/P) of the capacity of the negative catalyst layer relative to the capacity of the positive electrode may be about 0.1 to about 0.4, or about 0.1 to about 0.3.

The negative catalyst may be a carbon-based material, metal particles, or combinations thereof.

The carbon-based material may be amorphous carbon.

The metal particle may be at least one selected from Ag, Zn, Al, Sn, Mg, Ge, Cu, In, Ni, Bi, Au, Si, Pt, Pd, and combinations thereof.

The electrolyte may be a solid electrolyte. The solid electrolyte may be a sulfide-based solid electrolyte, an oxide-based solid electrolyte, a halide-based solid electrolyte, or a solid polymer electrolyte, as examples.

The negative electrode may further include a current collector supporting the negative catalyst layer, and may further include a lithium deposition layer formed between the current collector and the negative catalyst layer during an initial charging.

The positive active material may be an active material that is capable of reversibly intercalating and deintercalating lithium ions or a sulfur-based compound. In some embodiment, the positive active material may be the active material that is capable of reversibly intercalating and deintercalating lithium ions.

An all solid-state battery according to an embodiment may exhibit improved ionic conductivity and high rate capability.

### BRIEF DESCRIPTION OF THE DRAWINGS

Features will become apparent to those of skill in the art by describing in detail exemplary embodiments with reference to the attached drawings in which:

FIG. 1 is a schematic cross-sectional view of the all solid-state battery according to one embodiment.

FIG. 2 is a schematic cross-sectional view illustrating state of the all solid-state battery after charging according to one embodiment.

FIG. 3 is a SEM image of the surface of the negative electrode according to Example 1.

FIG. 4 is a graph showing the EDAX result for the negative electrode of Example 1.

FIG. 5 is image showing the SEM image of FIG. 3 magnified 20, 000 times.

FIG. 6 is a graph showing the EDAX results for the selected area 1 and the selected area of FIG. 5.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

In the embodiments, the terms “particle size” or “a particle diameter” may refer to an average particle diameter. The term “average particle diameter” may refer to an average particle diameter (D50) where a cumulative volume is about 50 volume % in a particle size distribution. The average particle size (D50) may be measured by a method well known to those skilled in the art, for example, by a particle size analyzer, or by a transmission electron microscopic image, or a scanning electron microscopic image. The laser diffraction may be obtained by distributing particles to be measured in a distribution solvent and introducing the distributed particles to a commercially available laser diffraction particle measuring device (e.g., MT 3000 available from Microtrac, Ltd.), irradiating ultrasonic waves of about 28 kHz at a power of 60 W, and calculating an average particle diameter (D50) in the 50% standard of particle distribution in the measuring device.

An all solid-state battery according to embodiments may include a positive electrode, a negative electrode, and an electrolyte. The negative electrode may include a negative active material layer including a negative catalyst and Nb₂O₅. A ratio (N/P) of a capacity of the negative catalyst layer relative to a capacity of the positive electrode may be about 0.1 or more, and less than about 0.5.

In some embodiments, the term “negative electrode including the negative catalyst layer” may refer to a deposition-type negative electrode. Such a deposition-type negative electrode may not include a negative active material in a preparation of the battery assembly, but instead, lithium metal may be deposited to serve as the negative active material during charging of the battery. To explain this in more detail, during the charging of an all solid-state battery, lithium ions may be released from a positive active material and may pass through the solid electrolyte to move to the negative electrode. Thus, the lithium ions may be deposited on the negative current collector to form a lithium deposition layer between the current collector and a negative layer. The negative electrode with the lithium deposition layer is called the “deposition-layer negative electrode”.

The negative electrode according to some embodiment may include Nb₂O₅ in the negative catalyst layer. Nb₂O₅ is a lithiophilic material and may be converted to LixNb₂O₅ during charging which, as a result, may operate as a pseudocapacitor) to distribute or to reserve lithium. Therefore, the ionic conductivity characteristic of the negative electrode may be improved.

Such effects may be realized by using Nb₂O₅ in the negative electrode of the battery having a ratio (N/P, hereinafter, referred to as “N/P” ratio) of about 0.1 or more, and less than about 0.5 of a capacity of the negative catalyst layer relative to a capacity of the positive electrode and using the Nb₂O₅ in an amount of about 1 wt % to about 30 wt % based on a total of 100 wt % of the negative catalyst layer.

In some embodiments, the N/P ratio does not indicate a ratio of a capacity of a negative electrode relative to a capacity of a positive electrode defined in the general lithium ion secondary battery, but instead indicates a ratio of a capacity of the negative catalyst layer relative to a capacity of the positive electrode. Herein, the term “capacity” refers to a charge capacity. The capacity of the negative catalyst layer may be obtained from a charge, in some embodiments, a charge capacity by lithium ions, if the lithium ions are moved to the negative electrode during charging to present the lithium ions in the negative catalyst layer.

In some embodiment, the capacity of the negative catalyst layer may be obtained by charging a half-cell including the negative electrode and a lithium counter electrode at about 0.01 C to about 0.1 C once to measure a capacity up to the inflection point near about 0 mV (vs. Li). The capacity of the positive electrode may be obtained from a theoretical capacity of a positive active material.

If the negative catalyst layer were to include Nb₂O₅, in an amount less than 1 wt %, this amount may be insufficient to provide the effects obtained by using Nb₂O₅ in the range indicated above. More than 30 wt % of Nb₂O₅ may create severe shortcomings due to the high irreversible capacity and low electrical conductivity of Nb₂O₅.

Even if the amount of Nb₂O₅ were to be within the above range, the desired effects may be not achieved, if the Nb₂O₅ is used in a battery having an N/P ratio out of the range of about 0.1 or more and less than about 0.5. If Nb₂O₅ is used in a battery having the N/P ratio of less than 0.1, the, negative catalyst layer may not function properly, and lithium may be non-uniformly grown. If Nb₂O₅ is used in a battery having the N/P ratio of 0.5 or more, too much lithium may be absorbed in the negative catalyst layer and thus, an irreversible capacity may occur due to dead lithium that does not participate in the charge and discharge reaction. The increases in the N/P ratio of the battery may cause an increase in the thickness of the negative electrode. In the all solid-state battery according to some embodiment, the negative electrode may not include any solid electrolyte, which lithium ionic conductivity to be low. Thus, increases in the thickness of the negative electrode may not readily allow for charging and discharging. Thereby no objective effects may be exhibited.

If the N/P ratio is less than 1, a deposition-type negative electrode may result in which lithium ions moved to the negative electrode during charge reacts as LiCx (where x=1 to 6) (during the initial charge, a capacity up to 0 V (vs. Li/Li+)) and the unreacted and residual ions are deposited between the negative catalyst layer and the current collector. In some embodiments, if the maximum value of the N/P ration is less than 0.5, the battery may be regarded as a battery in which an amount of lithium deposited on a surface of the negative electrode may be larger than the general deposition-type negative electrode.

In some embodiments, an amount of Nb₂O₅ may be about 1 wt % to about 30 wt %, about 3 wt % to 30 wt %, about 3 wt % to about 20 wt %, about 5 wt % to about 15 wt %, about 5 wt % to about 10 wt % based on the total, 100 wt % of the negative catalyst layer.

In some embodiments, the N/P ratio may be about 0.1 or more, and less than about 0.5, about 0.1 to about 0.4, or about 0.1 to about 0.3, or about 0.1 to about 0.2.

The negative catalyst layer may include a carbon-based material, metal particles, or combinations thereof, as the negative catalyst. If the all solid battery according to an embodiment is charged, lithium ions may be released from a positive active material and may pass through the solid electrolyte to move to the negative electrode, and thus, is the lithium ions may be deposited on the negative current collector to form a lithium deposition layer. The carbon-based material may be a sp3-rich carbon-based material that is favorable for deposition. For example, the carbon-based material may be carbon black, acetylene black, denka black, ketjen black, furnace black, activated carbon, graphene, or combinations thereof. The carbon black may be Super P (available from Timcal, Ltd.) The amorphous carbon is not limited thereto, and any available material that may be classified as amorphous carbon may be used.

The amorphous carbon may include single particles, a secondary particle in which primary particles are agglomerated, or combinations thereof.

The single particles may have a particle diameter of about 10 nm to about 60 m. In other embodiments, a particle diameter of the primary particles may be about 20 nm to about 100 nm, and a particle diameter of the secondary particle may be about 1 m to about 20 μm.

In some embodiments, a particle diameter of the primary particles may be about 20 nm or more, about 30 nm or more, about 40 nm or more, about 50 nm or more, about 60 nm or more, about 70 nm or more, about 80 nm or more, or about 90 nm or more, and about 100 nm or less, about 90 nm or less, about 80 nm or less, about 70 nm or less, about 60 nm or less, about 50 nm or less, about 40 nm or less, or about 30 nm or less.

In some embodiments, a particle diameter of the secondary particle may be about 1 μm or more, about 3 μm or more, about 5 μm or more, about 7 μm or more, about 10 μm or more, or about 15 μm or more, and about 20 μm or less, about 15 μm or less, about 10 μm or less, about 7 μm or less, about 5 μm or less, or about 3 μm or less.

The shape of the primary particle may be spherical, oval, plate-shaped, or combinations thereof. In some embodiments, the shape of the primary particle may be spherical, oval, or combinations thereof.

The metal nanoparticle may be Ag, Zn, Al, Sn, Mg, Ge, Cu, In, Ni, Bi, Au, Si, Pt, Pd, and combinations thereof. In some embodiments, the metal nanoparticle may be Ag. The inclusion of the metal nanoparticles in the negative catalyst layer may further improve the electrical conductivity of the negative electrode.

The metal particle may have a size of about 5 nm to about 800 nm. The size of the metal particle may be about 5 nm or more, about 50 nm or more, about 100 nm or more, about 150 nm or more, about 200 nm or more, about 250 nm or more, about 300 nm or more, about 350 nm or more, about 400 nm or more, about 450 nm or more, about 500 nm or more, 550 nm or more, 600 nm or more, 650 nm or more, 700 nm or more, or 750 nm or more. The size of the metal particle may be about 800 nm or less, about 750 nm or less, about 700 nm or less, about 650 nm or less, about 600 nm or less, about 550 nm or less, about 500 nm or less, about 450 nm or less, about 400 nm or less, about 350 nm or less, about 300 nm or less, about 250 nm or less, about 200 nm or less, about 150 nm or less, about 100 nm or less, or about 50 nm or less. If the size of the metal particle is within the above range battery characteristics, for example, cycle-life characteristics of the all solid-state battery, may be improved.

If the negative catalyst layer includes the carbon-based material and the metal particles, a mixing ratio of the carbon-based material and the metal particles may be about 1:1 to about 99:1 by weight ratio. For example, an amount of the carbon-based material may be, based on the metal particle, about 1 or more, about 2 or more, about 3 or more, about 4 or more, about 5 or more, about 10 or more, about 15 or more, about 20 or more, about 25 or more, about 30 or more, about 35 or more, about 40 or more, about 45 or more, about 50 or more, about 55 or more, about 60 or more, about 65 or more, about 70 or more, about 75 or more, about 80 or more, about 85 or more, about 90 or more or about 95 or more, and about 99 or less, about 95 or less, about 90 or less, about 85 or less, about 80 or less, about 75 or less, about 70 or less, about 65 or less, about 60 or less, about 55 or less, about 50 or less, about 45 or less, about 40 or less, about 35 or less, about 30 or less, about 25 or less, about 20 or less, about 15 or less, about 10 or less, about 5 or less, about 4 or less, about 3 or less or about 2 or less. For example, the weight ratio of the carbon-based material and the metal particles may be about 1:1 to about 5:1, about 1:1 to about 10:1, about 1:1 to about 20:1, about 1:1 to about 25:1, about 1:1 to about 30:1, about 1:1 to about 40:1, about 1:1 to about 50:1, about 1:1 to about 60:1, about 1:1 to about 70:1, about 1:1 to about 80:1, or about 1:1 to about 90:1. If weight ratio of the carbon-based material and the metal particles is within the range, the electrical conductivity of the negative electrode may be more improved.

The carbon-based material, metal particles, or combinations thereof may be present in an amount of about 50 wt % to about 98 wt %, or about 60 wt % to about 90 wt % based on the total weight of the negative catalyst layer.

The negative catalyst layer may include a binder and may further include a conductive material.

The binder may be, for example, a styrene butadiene rubber (SBR), polytetrafluoroethylene, polyvinylidene fluoride, polyethylene, a vinylidenefluoride/hexafluoropropylene copolymer, polyacrylonitrile, polymethylmethacrylate, carboxymethyl cellulose, hydroxypropyl cellulose, diacetyl cellulose, or combinations thereof. The carboxymethyl cellulose, hydroxypropyl cellulose, diacetyl cellulose may be alkali metals thereof, and the alkali metal may be Na or Li, as non-limiting examples Any available binder may be used as a binder in the related art.

An amount of the binder may be, based on the total weight of each component of the negative electrode for the all solid-state battery, or the total weight of the negative catalyst layer, about 0.1 wt % to about 30 wt %, or about 0.1 wt % to about 10 wt %. The binder within the above range may sufficiently exhibit the adherence without deteriorating the battery performances.

The conductive material is included to provide electrode conductivity. Any electrically conductive material may be used as a conductive material unless it causes a chemical change. Examples of the conductive material may be a carbon-based material such as natural graphite, artificial graphite, carbon black, acetylene black, ketjen black, carbon fiber, carbon nanofiber, carbon nanotube, and the like; a metal-based material of a metal powder or a metal fiber including copper, nickel, aluminum, silver, and the like; a conductive polymer such as polyphenylene derivatives; or mixtures thereof.

The conductive material may be included in an amount of about 0.1 wt % to about 15 wt %, or about 0.1 wt % to about 10 wt % based on the total weight of each component of the negative electrode for the all solid-state battery, or the total weight of the negative catalyst layer. The conductive material within the above range may sufficiently exhibit the electrical conductivity without deteriorating the battery performances.

The negative electrode may further include a current collector supporting the negative catalyst layer. The current collector may be, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape.

The negative catalyst layer may further include, for example, additives such as a filler, a dispersing agent, an ionic conductive material, and the like. As the filler, the dispersing agent, the ionic conductive material included in the negative catalyst layer, a generally used for the all solid-state battery may be used.

The positive electrode may include a positive active material layer including a positive active material and a current collector supporting the positive active material layer.

The positive active material may include compounds that reversibly intercalate and deintercalate lithium ions. For example, the positive active material may include one or more composite oxides of a metal selected from cobalt, manganese, nickel, and a combination thereof, and lithium. The examples of the positive active material may be LiaA1-bB1bD12 (0.90≤a≤1.8, 0≤b≤0.5); LiaE1-bB1bO2-cD1c (0.90≤a≤1.8, 0≤b≤0.5, 0≤c≤0.5); LiaE2-bB1bO4-cD1c (0.90≤a≤1.8, 0≤b≤0.5, 0c≤05); LiaNi1-b-cCobB1cD1α (0.90≤a≤1.8, 0≤b≤0.5, 0≤c≤0.5, 0<α≤2); LiaNi1-b-cCobB1cO2-αF1α (0.90≤a≤1.8, 0≤b≤0.5, 0≤c≤0.5, 0<α<2); LiaNi1-b-cCobB1cO2-αF12 (0.90≤a≤1.8, 0≤b≤0.5, 0≤c≤0.5, 0<α<2); LiaNi1-b-cMnbB1cD1α (0.90≤a≤1.8, 0b≤0.5, 0≤c≤0.5, 0<α≤2); LiaNi1-b-cMnbB1cO2-αF1α (0.90≤a≤1.8, 0≤b≤0.5, 0≤c≤0.5, 0<α<2); LiaNi1-b-cMnbB1cO2-αF12 (0.90≤a≤1.8, 0≤b≤0.5, 0≤c≤0.5, 0<α<2); LiaNibEcGdO2 (0.90≤a≤1.8, 0≤b≤0.9, 0≤c≤0.5, 0.001≤d≤0.1); LiaNibCocMndGeO2 (0.90≤a≤1.8, 0≤b≤0.9, 0≤c≤0.5, 0≤d≤0.5, 0.001≤e≤0.1); LiaNiGbO2 (0.90≤a 1.8, 0.001≤b≤0.1); LiaCoGbO2 (0.90≤a≤1.8, 0.001≤b≤0.1); LiaMnGbO2 (0.90≤a≤1.8, 0.001≤b≤0.1); LiaMn2GbO4 (0.90≤a≤1.8, 0.001≤b≤0.1); QO2; QS2; LiQS2; V2O5; LiV2O5; LiI1O2; LiNiVO4; Li (3−f)J2(PO4)3 (0≤f≤2); Li (3−f)Fe2(PO4)3 (0≤f≤2); or LiFePO4.

In the chemical formulae, A is selected from Ni, Co, Mn, or combinations thereof; B1 is selected from Al, Ni, Co, Mn, Cr, Fe, Mg, Sr, V, a rare earth element, or combinations thereof; D1 is selected from O, F, S, P, or combinations thereof, E is selected from Co, Mn, or combinations thereof; F1 is selected from F, S, P, or combinations thereof; G is selected from Al, Cr, Mn, Fe, Mg, La, Ce, Sr, V, or combinations thereof; Q is selected from Ti, Mo, Mn, or combinations thereof; Il is selected from Cr, V, Fe, Sc, Y, or combinations thereof; J is selected from V, Cr, Mn, Co, Ni, Cu, or combinations thereof.

According to some embodiments, the positive active material may be a three-component-based lithium transition metal oxide such as LiNixCoyAlzO2 (NCA), LiNixCoyMnzO2 (NCM), ( [symbol] , 0<x<1, 0<y<1, 0<z<1, x+y+z=1) (wherein, 0<x<1, 0<y<1, 0<z<1, x+y+z=1), etc.

The compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or mixture thereof. The coating layer may be provided by a method having no (or substantially no) adverse influence on properties of a positive active material by using these elements in the compound. For example, the method may include any suitable coating method such as spray coating, dipping, and/or the like, but is not illustrated in more detail because it should be readily recognizable to those of ordinary skill in the art upon reviewing the present disclosure.

Furthermore, the coating layer may be any coating materials that are known as a coating layer for the positive active material of the all-solid state battery. For example, the coating material may be Li2O—ZrO2 (LZO), and the like.

The shape of the positive active material may be, for example, a particle shape such as a spherical shape or an oval spherical shape. The average particle diameter of the positive active material may not be limited, and may be in any range that can be applied to a positive active material of a conventional all solid-state secondary battery. The amount of the positive active material included in the positive active material may not be limited, and may be in any range that may be applied to a positive active material of the conventional all solid-state secondary battery.

In some embodiments, the positive active material may be included in an amount of amount of about 55 wt % to about 99.7 wt %, or for example, about 74 wt % to about 89.8 wt % based on the total weight of the positive active material layer. If the positive active material is included within the range, the capacity of the all-solid-state battery may be maximized and the cycle-life characteristics may be improved.

The positive active material layer may include a solid electrolyte. The solid electrolyte may be an inorganic solid electrolyte such as a sulfide-based solid electrolyte, an oxide-based solid electrolyte, or a solid polymer electrolyte.

The sulfide-based solid electrolyte may be, for example, Li2S—P2S5, Li2S—P2S5-LiX (where X is an halogen element, for example, I, or Cl), Li2S—P2S5-Li2O, Li2S—P2S5-Li2O—LiI, Li2S—SiS2, Li2S-SiS2-LiI, Li2S-SiS2-LiBr, Li2S-SiS2-LiCl, Li2S-SiS2-B2S3-LiI, Li2S-SiS2-P2S5-LiI, Li2S—B2S3, Li2S—P2S5-ZmSn (where m and n are each an integer, Z is Ge, Zn or Ga), Li2S—GeS2, Li2S-SiS2-Li3PO4, Li2S-SiS2-LipMOq (where p and q are each an integer, and M is P, Si, Ge, B, Al, Ga, or In), or the like.

The sulfide-based solid electrolyte may be prepared, for example, by mixing Li2S and P2S5 at a mole ratio of about 50:50 to about 90:10, or about 50:50 to about 80:20. In the mixing ratio, a sulfide-based solid electrolyte exhibiting excellent ionic conductivity may be prepared. As other components, SiS2, GeS2, B2S3, or the like may be further included thereto, thereby further improving ionic conductivity. The mixing procedure may be performed by mechanical milling or by a solution method. The mechanical milling may be performed by adding starting sources, a ball mill, or the like, in a reactor and vigorously stirring to pulverize the starting sources and mix them together. The solution method may provide a solid electrolyte as a precipitate by mixing starting sources in a solvent. After mixing, an additional sintering procedure may be performed. The crystal of the solid electrolyte may be further solidified by performing addition sintering.

For example, the solid electrolyte may be an argyrodite-type sulfide-based solid electrolyte. The sulfide-based solid electrolyte may be, for example, LiaMbPcSdAe (where a, b, c, d and e are all about 0 or more and about 12 or more, M is Ge, Sn, Si, or combinations thereof, and A is one of F, Cl, Br, or I), and in another embodiment, may be Li3PS4, Li7P3S11, Li6PS5Cl, Li6PS5Br, Li6PS5I, or the like.

The sulfide-based solid electrolyte may be amorphous, crystalline, or a combination thereof.

The oxide-based inorganic solid electrolyte may be, for example, Li1+xTi2−xAl(PO4)3 (LTAP) (0≤x≤4), Li1+x+yAlxTi2−xSiyP3−yO12 (0<x<2, 0≤y<3), BaTiO3, Pb(Zr,Ti)O3 (PZT), Pb1−xLaxZr1−yTiyO3 (PLZT) (0≤x<1, 0≤y<1), PB (Mg3Nb2/3)O3-PbTiO3 (PMN—PT), HfO2, SrTiO3, SnO2, CeO2, Na2O, MgO, NiO, CaO, BaO, ZnO, ZrO2, Y2O3, Al2O3, TiO2, SiO2, lithium phosphate (Li3PO4), lithium titanium phosphate (LixTiyPO4)3, 0<x<2, 0<y<3), Li1+x+y(Al, Ga)x(Ti, Ge)2−xSiyP3−yO12 (0≤x≤1, 0≤y≤1), lithium lanthanum titanate (LixLayTiO3, 0<x<2, 0<y<3), Li2O, LiAlO2, Li2O—Al2O3-SiO2-P2O5-TiO2-GeO2 ceramics, Garnet-based ceramics Li3+xLa3M2O12 (M=Te, Nb, or Zr; x is an integer of about 1 to about 10), or mixtures thereof.

The solid polymer electrolyte may be, for example, at least one of polyethylene oxide, poly(diallyldimethyl ammonium)TFSI), Cu3N, Li3N, LiPON, Li3PO4·Li2S·SiS2, Li2S·GeS2·Ga2S3, Li2O·11Al2O3, Na2O·11Al2O3, (Na,Li)1+xTi2−xAlx(PO4)3 (0.1≤x≤0.9), Li1+xHf2−xAlx(PO4)3 (0.1≤x≤0.9), Na3Zr2Si2PO12, Li3Zr2Si2PO12, Na5ZrP3O12, Na5TiP3O12, Na3Fe2P3O12, Na4NbP3O12, Na-Silicates, Li0.3La0.5TiO3, Na5MSi4O12 (M is a rare earth element such as Nd, Gd, Dy, or the like) Li5ZrP3O12, Li5TiP3O12, Li3Fe2P3O12, Li4NbP3O12, Li1+x(M,Al,Ga)x(Ge1−yTiy)2−x(PO4)3 (x≤0.8, 0≤y≤1.0, and M is Nd, Sm, Eu, Gd, Tb, Dy, Ho, Er, Tm, or Yb), Li1+x+yQxTi2−xSiyP3−yO12 (0<x≤0.4, 0<y≤0.6, and Q is Al or Ga), Li6BaLa2Ta2O12, Li7La3Zr2O12, Li5La3Nb2O12, Li5La3M2O12 (M is Nb, Ta), or Li7+xAxLa3−xZr2O12 (0<x<3 and A is Zn).

The solid electrolyte may have a particle shape, and may have an average particle diameter (D50) of about 5.0 μm or less, about 0.1 μm to about 5.0 μm, about 0.5 μm to about 5.0 μm, about 0.5 μm to about 4.0 μm, about 0.5 μm to about 3.0 μm, about 0.5 μm to about 2.0 μm, or about 0.5 μm to about 1.0 μm.

An amount of the solid electrolyte may be, based on the weight of the negative catalyst layer, about 0.1 wt % to about 35 wt %, and for example, about 1 wt % to about 35 wt %, about 5 wt % to about 30 wt %, about 8 wt % to about 25 wt %, or about 10 wt % to about 20 wt %.

Based on the total weight of the positive active material layer, the solid electrolyte may be included in an amount of about 0.1 wt % to about 35 wt %, and for example, about 1 wt % to about 35 wt %, about 5 wt % to about 30 wt %, about 8 wt % to about 25 wt %, or about 10 wt % to about 20 wt %. Based on the total weight of the positive active material and the solid electrolyte in the positive active material layer, the positive active material may be included in an amount of about 65 wt % to about 99 wt % and the solid electrolyte may be included in an amount of about 1 wt % to about 35 wt %, and in another embodiments, the positive active material may be included in an amount of about 80 wt % to about 90 wt % and the solid electrolyte may be included in an amount of about 10 wt % to about 20 wt %. If the solid electrolyte is included in the positive electrode within the weight range, the cycle-life characteristics and efficiency of the all solid-state battery may be improved, without deteriorating the capacity.

The positive active material layer may include a binder. The binder may improve binding properties of positive active material particles with one another and with a current collector.

The binder may be polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinylpyrrolidone, polyurethane, polytetrafluoroethylene, polyvinylidene fluoride, a vinylidene fluoride-hexafluoropropylene copolymer, polyethylene, polypropylene, a styrene butadiene rubber, an acrylated styrene butadiene rubber, polyacrylonitrile, an epoxy resin, nylon, poly(metha)acrylate, polymethyl(metha)acrylate, or the like, as non-limiting examples.

Among these, the binder according to some embodiments may be at least one selected from polyvinylidene fluoride, a vinylidene fluoride-hexafluoropropylene copolymer, polytetrafluoroethylene, a styrene butadiene rubber, polyacrylonitrile, or polymethyl(metha)acrylate.

Based on the total weight of each component of the positive electrode for the all solid-state battery, or the total weight of the positive active material layer, the binder may be about 0.1 wt % to about 5 wt %, or about 0.1 wt % to about 3 wt %. In the range of amount, adhesion may be sufficiently secured without the deterioration of the battery performances.

The positive active material layer may further include a conductive material. The conductive material may be included to provide electrode conductivity. Any electrically conductive material that does not cause a chemical change may be used as a conductive material. Examples of the conductive material may include a carbon-based material such as natural graphite, artificial graphite, carbon black, acetylene black, ketjen black, carbon fiber, carbon nanofiber, carbon nanotube and the like; a metal-based material of a metal powder or a metal fiber including; copper, nickel, aluminum, silver, and the like; material; a conductive polymer such as polyphenylene derivatives; or mixtures thereof.

The conductive material may be included at about 0.1 wt % to 5 wt %, or 0.1 wt % to about 3 wt % based on the total amounts of each component of the positive electrode for the all solid-state battery, or the total amounts of the positive active material layer. The conductive material at the above range may improve the electrical conductivity without deteriorating battery performances.

The current collector may be, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape.

The electrolyte layer may include a solid electrolyte. The solid electrolyte may be an inorganic solid electrolyte such as a sulfide-based solid electrolyte, an oxide-based solid electrolyte, a halide-based solid electrolyte, and the like, or a solid polymer electrolyte.

The sulfide-based solid electrolyte, the oxide-based solid electrolyte and the solid polymer electrolyte are as described above.

The halide-based solid electrolyte may include an Li element, an M element (where M is a metal except for Li), and an X element (where X is a halogen). The X may be, for example, F, Cl, Br and I. In some embodiments, the halide-based solid electrolyte may include at least one of Br and Cl, as the X. The M may be, for example, a metal element such as Sc, Y, B, Al, Ga, In, and the like.

The composition of the halide-based solid electrolyte is not limited, but in some implementations, the halide-based solid electrolyte may be represented by Li6-3aMaBrbClc (where, M is metals, except for Li, 0<a<2, 0≤b≤6, 0≤c≤6, b+c=6). The a may be about 0.75 or more, or about 1 or more. in some implementations, the a may be about 1.5 or less. The b may be about 1 or more, or about 2 or more. The c may be about 3 or more, or about 4 or more. The exemplary of the halide-based solid electrolyte may be Li3YBr6, Li3YCl6 or Li3YBr2Cl4.

The solid electrolyte may have particle shapes and may have an average particle diameter (D50) of about 5.0 μm or less, for example, about 0.1 μm to about 5.0 μm, about 0.5 μm to about 5.0 μm, about 0.5 μm to about 4.0 μm, about 0.5 μm to about 3.0 μm, about 0.5 μm to about 2.0 μm, or about 0.5 μm to about 1.0 μm.

The solid electrolyte layer may further include a binder in addition to a solid electrolyte. The binder may be a styrene butadiene rubber, polytetrafluoroethylene, polyvinylidene fluoride, polyethylene, an acrylate-based polymer, or a combination thereof, and may be any material that is generally used in the related art. The acrylate-based polymer may be, for example, butyl acrylate, polyacrylate, polymethacrylate, or combinations thereof.

The solid electrolyte layer may be prepared by adding the solid electrolyte to a binder solution, coating the binder solution onto a substrate film, and drying the binder solution. The binder solution may include isobutylyl isobutylate, xylene, toluene, benzene, hexane, or combinations thereof, or may be a compound represented by Chemical Formula 1 and/or a compound represented by Chemical Formula 2. The solid electrolyte layer preparation is widely known in the art, so a detailed description thereof will not be repeated in the specification.

The solid electrolyte layer may have a thickness of about 10 μm to about 150 m.

The solid electrolyte layer may further include an alkali metal salt, and/or an ionic liquid, and/or a conductive polymer.

The alkali metal salt may be, for example, a lithium salt. In the solid electrolyte layer, an amount of the lithium salt may be about 1 M or more, for example, about 1 M to about 4 M. The lithium salt with the described amount may improve the lithium ion mobility of the solid electrolyte layer, thereby improving the ionic conductivity.

The lithium salt, may be, for example, LiSCN, LiN(CN)2, Li(CF3SO2)3C, LiC4F9SO3, LiN(SO2CF2CF3)2, LiCl, LiF, LiBr, LiI, LiB(C2O4)2, LiBF4, LiBF3 C2F5, lithium bis(oxalato) borate (LiBOB), lithium oxalyldifluoro borate (LIODFB), lithium difluoro(oxalato)borate, (LiDFOB), lithium bis(trifluoro methanesulfonyl)imide, LiTFSI, LiN(SO2CF3)2), lithium bis(fluorosulfonyl)imide, LiFSI, LiN(SO2F)2), LiCF3SO3, LiAsF6, LiSbF6, LiClO4, or mixtures thereof.

The lithium salt may be imide-based. For example, the imide-based lithium salt may be lithium bis(trifluoro methanesulfonyl)imide, LiTFSI, LiN(SO2CF3)2), lithium bis(fluorosulfonyl)imide, LiFSI, or LiN(SO2F)2). The lithium salt may suitably maintain the chemical reactivity with the ionic liquid, and thus, the ionic conductivity may be maintained or improved.

The ionic liquid may have a melting point of room temperature or less. The ionic liquid may be in a liquid state at a room temperature with salts consisting of only ion, or a room-temperature molten salt.

The ionic liquid may be a compound including a) at least one cation selected from ammonium-based, pyrroleridinium-based, pyridinium-based, pyrrimidinuim-based, imidazolium-based, piperidinum-based, pyrazolium-based, oxazolium-based, pyridazium-based, phosphonium-based, sulfonium-based, triazolium-based, or a mixture thereof, and or more positive ion and b) at least one anion selected from BF4-, PF6-, AsF6-, SbF6-, AlCl4-, HSO4-, ClO4-, CH3SO3-, CF3CO2-, Cl—, Br—, I—, BF4-, SO4-, CF3SO3-, (FSO2)2N—, (C2F5SO2)2N—, (C2F5SO2)CF3SO2)N—, or (CF3SO2)2N—.

The ionic liquid may be, for example, at least one selected from N-methyl-N-propylpyrroledinium bis(trifluoromethanesulfonyl)imide N-butyl-N-methylpyrroleridinium bis (3-trifluoromethylsulfonyl)imide, 1-butyl-3-methylimidazoleium bis(trifluoromethylsulfonyl)amide, 1-ethyl-3-methylimidazoleium, or bis(trifluoromethylsulfonyl)amide.

In the solid electrolyte layer, the weight ratio of the solid electrolyte and the ionic liquid may be about 0.1:99.9 to about 90:10, for example, about 10:90 to about 90:10, about 20:80 to about 90:10, about 30:70 to about 90:10, about 40:60 to about 90:10, or about 50:50 to about 90:10. The solid electrolyte layer within the range may have an improved electrochemical contact area to the electrode. Thus, the ionic conductivity may be maintained or improved. The improved electrochemical contact area may improve the energy density, discharge capacity, rate capability, or the like of the all solid-state battery.

The all solid-state battery according to some embodiments may be referred to as an all solid-state secondary battery, or an all solid-state lithium secondary battery.

If the all solid-state battery according to some embodiments is charged, lithium ions may be released from a positive active material and may pass through the solid electrolyte to move to the negative electrode. Thus, the lithium ions may be deposited to the negative current collector to form a lithium deposition layer. That is, the lithium deposition layer may be formed between the negative current collector and the negative active material layer.

The charging may include a formation process that can be performed at 0.05 C to 1 C at about 25° C. to about 50° C. once to three times.

The lithium deposition layer may have a thickness of about 10 μm to about 50 μm. For example, the thickness of the lithium deposition layer may be about 10 μm or more, about 20 μm or more, about 30 μm or more, or about 40 μm or more, and about 50 μm or less, about 40 μm less, about 30 μm less, or about 20 μm less. If the thickness of the lithium deposition layer is present within in the range, the lithium may be reversibly deposited during charge and discharge, thereby further improving the cycle-life characteristics.

In embodiments, the all solid-state battery may further include a buffer material for buffering a thickness variation caused by charging and discharging. The buffer material may be positioned between the negative electrode and the case, or between the one assembly and another assembly of the battery in which at least one electrode assembly is stacked.

The buffer material may include materials having an elasticity recovery rate of about 50% or more and insulating properties. In another embodiment, the buffer material may be silicon rubber, acryl rubber, fluorine-based rubber, nylon, synthetic rubber, or combinations thereof. The buffer material may be a polymer sheet.

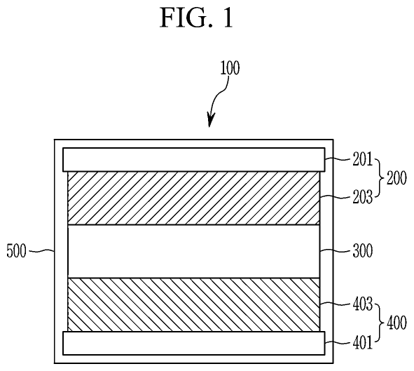

FIG. 1 is a cross-sectional view showing the all solid-state battery according to embodiments. Referring to FIG. 1, the all solid-state battery 100 may have a structure in which an electrode assembly is stacked with a negative electrode 400 including a negative current collector 401 and a negative catalyst layer 403, a solid electrolyte layer 300, a positive electrode 200 including a positive current collector 201 and a positive active material layer 203 are housed on a case such as a pouch, or the like. The all solid-state battery 100 may further include an elasticity layer 500 on the outside of at least one of the positive electrode 200 and the negative electrode 400. FIG. 1 shows one electrode assembly including a negative electrode 400, the solid electrolyte layer 300, and a positive electrode 200. In some implementations, an all solid-state battery may be fabricated by stacking at least two electrode assembly.

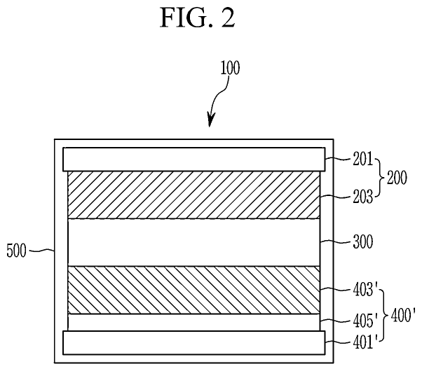

FIG. 2 schematically shows the structure of the all solid-state battery in the charge state. The all solid-state battery 100 may include a positive electrode 200 including a positive current collector 201 and a positive active material layer 203, a negative electrode 400 including a negative current collector 401 and a negative catalyst layer 403. The solid electrolyte layer 300 may be positioned between the positive electrode 200 and the negative electrode 400, and may include a battery case housing the battery.

As shown in FIG. 2, if the all solid-state battery 100 is charged, lithium ions may be released from a positive active material and deposited on the negative current collector 401′, thereby forming a lithium deposition layer 405′ between the current collector 401′ and the negative catalyst layer 403′.

Hereinafter, examples of the present disclosure and comparative examples are described. These examples, however, are not in any sense to be interpreted as limiting the scope thereof.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

(1) Preparation of Negative Electrode

8 wt % of a Li-carboxymethyl cellulose binder, 5 wt % or Ag nanoparticles (D50: 60 nm), 86 wt % of carbon black, and 1 wt % of Nb₂O₅ were mixed in a water solvent to prepare a negative catalyst layer slurry. The carbon black was a mixture of single particles with a particle diameter of 38 nm and secondary particles. The secondary particles had a particle diameter of 275 nm in which primary particles having a particle diameter of 76 nm were aggregated.

The slurry was coated onto a stainless steel foil current collector and vacuum-dried at 100° C. to prepare a negative electrode having a negative catalyst layer with a 5 μm thickness and a current collector with a 10 μm thickness.

(2) Preparation of Positive Electrode

85.00 wt % of a LiNi0.8Co0.1Al0.1O2 positive active material, 13.5 wt % of an argyrodite-type solid electrolyte Li6PS5Cl, 0.5 wt % of a carbon nanotube conductive material, and 1.0 wt % of a polyvinylidene fluoride binder 1.0 wt % were mixed in an N-methyl pyrrolidone solvent to prepare a positive active material layer slurry.

The positive active material layer slurry was coated onto an aluminum current collector and dried at 60° C. followed by pressurizing to prepare a positive electrode for an all solid-state battery.

(3) Preparation of Solid Electrolyte Layer

To an argyrodite-type solid electrolyte Li6PS5Cl, an butyl acrylate binder solution (solid amount: 50 wt %) to which isobutylyl isobutylate as an acrylate-based polymer had been added, was added and mixed therewith. The mixing ratio of the solid electrolyte and the binder was prepared to be 98.7:1.3 by weight ratio.

The mixing was performed by using a Thinky mixer. 2 mm zirconia balls were added to the obtained mixture and were repeatedly mixed with the Thinky mixer to prepare a slurry. The slurry was cast onto a release polytetrafluoroethylene film and dried at room temperature to prepare a solid electrolyte layer with a thickness of 5 μm.

(4) Preparation of all Solid-State Cell

The negative electrode, the solid electrolyte and the positive electrode were sequentially stacked and a pressure of 2 Nm was applied thereto, thereby fabricating an all solid-state cell. In the cell, a thickness of the positive active material layer or lithium (excepting for a current collector) was 100 μm to 150 μm. A thickness of the negative catalyst layer (excepting for a current collector) was 5 μm to 10 μm, and a thickness of the solid electrolyte layer was 100 μm.

### Example 2

A negative electrode was prepared by the same procedure as in Example 1, except that 8 wt % of a mixed binder of Li-carboxymethyl cellulose (Li-CMC) and a styrene butadiene rubber (SBR) (Li-CMC:SBR=1:2 weight ratio), 4 wt % of Ag nanoparticles (D50: 60 nm), 85 wt % of carbon black, and 3 wt % of Nb₂O₅ were mixed in a water solvent to prepare a negative catalyst layer slurry.

Using the negative electrode, the positive electrode and the solid electrolyte of Example 1, an all solid-state cell was fabricated by the same procedure as in Example 1.

### Example 3

A negative electrode was prepared by the same procedure as in Example 1, except that 8 wt % of a mixed binder of Li-carboxymethyl cellulose (Li-CMC) and a styrene butadiene rubber (SBR) (Li-CMC:SBR=1:2 weight ratio), 4 wt % of Ag nanoparticles (D50: 60 nm), 83 wt % of carbon black, and 5 wt % of Nb₂O₅ were mixed in a water solvent to prepare a negative catalyst layer slurry.

Using the negative electrode, the positive electrode, and the solid electrolyte of Example 1, an all solid-state cell was fabricated by the same procedure as in Example 1.

### Example 4

A negative electrode was prepared by the same procedure as in Example 1, except that 8 wt % of a mixed binder of Li-carboxymethyl cellulose (Li-CMC) and a styrene butadiene rubber (SBR) (Li-CMC:SBR=1:2 weight ratio), 4 wt % of Ag nanoparticles (D50: 60 nm), 78 wt % of carbon black, and 10 wt % of Nb₂O₅ were mixed in a water solvent to prepare a negative catalyst layer slurry.

Using the negative electrode, the positive electrode, and the solid electrolyte of Example 1, an all solid-state cell was fabricated by the same procedure as in Example 1.

### Example 5

A negative electrode was prepared by the same procedure as in Example 1, except that 8 wt % of a mixed binder of Li-carboxymethyl cellulose (Li-CMC) and a styrene butadiene rubber (SBR) (Li-CMC:SBR=1:2 weight ratio), 4 wt % of Ag nanoparticles (D50: 60 nm), 64 wt % of carbon black, and 25 wt % of Nb₂O₅ were mixed in a water solvent to prepare a negative catalyst layer slurry.

Using the negative electrode, the positive electrode, and the solid electrolyte of Example 1, an all solid-state cell was fabricated by the same procedure as in Example 1.

### Example 6

A negative electrode was prepared by the same procedure as in Example 1, except that 8 wt % of a mixed binder of Li-carboxymethyl cellulose (Li-CMC) and a styrene butadiene rubber (SBR) (Li-CMC:SBR=1:2 weight ratio), 3 wt % of Ag nanoparticles (D50: 60 nm), 59 wt % of carbon black, and 30 wt % of Nb₂O₅ were mixed in a water solvent to prepare a negative catalyst layer slurry.

Using the negative electrode, the positive electrode, and the solid electrolyte of Example 1, an all solid-state cell was fabricated by the same procedure as in Example 1.

### Example 7

A negative electrode was prepared by the same procedure as in Example 1, except that 8 wt % of a mixed binder of Li-carboxymethyl cellulose (Li-CMC) and a styrene butadiene rubber (SBR) (Li-CMC:SBR=1:2 weight ratio), 82 wt % of carbon black, and 10 wt % of Nb₂O₅ were mixed in a water solvent to prepare a negative catalyst layer slurry.

Using the negative electrode, and the positive electrode and the solid electrolyte of Example 1, an all solid-state cell was fabricated by the same procedure as in Example 1.

### Example 8

A negative electrode was prepared by the same procedure as in Example 1, except that 8 wt % of a mixed binder of Li-carboxymethyl cellulose (Li-CMC) and a styrene butadiene rubber (SBR) (Li-CMC:SBR=1:2 weight ratio), 62 wt % of carbon black, and 30 wt % of Nb₂O₅ were mixed in a water solvent to prepare a negative catalyst layer slurry.

Using the negative electrode, and the positive electrode and the solid electrolyte of Example 1, an all solid-state cell was fabricated by the same procedure as in Example 1.

### Comparative Example 1

A negative electrode was prepared by the same procedure as in Example 1, except that 8 wt % of a mixed binder of Li-carboxymethyl cellulose (Li-CMC) and a styrene butadiene rubber (SBR) (Li-CMC:SBR=1:2 weight ratio), 4.2 wt % of Ag nanoparticles (D50: 60 nm), 87 wt % of carbon black, and 0.8 wt % of Nb₂O₅ were mixed in a water solvent to prepare a negative catalyst layer slurry.

Using the negative electrode, the positive electrode, and the solid electrolyte of Example 1, an all solid-state cell was fabricated by the same procedure as in Example 1.

### Comparative Example 2

A negative electrode was prepared by the same procedure as in Example 1, except that 8 wt % of a mixed binder of Li-carboxymethyl cellulose (Li-CMC) and a styrene butadiene rubber (SBR) (Li-CMC:SBR=1:2 weight ratio), 3 wt % of Ag nanoparticles (D50: 60 nm), 57 wt % of carbon black, and 32 wt % of Nb₂O₅ were mixed in a water solvent to prepare a negative catalyst layer slurry.

Using the negative electrode, and the positive electrode and the solid electrolyte of Example 1, an all solid-state cell was fabricated by the same procedure as in Example 1.

### Comparative Example 3

A negative electrode was prepared by the same procedure as in Example 1, except that 8 wt % of a mixed binder of Li-carboxymethyl cellulose (Li-CMC) and a styrene butadiene rubber (SBR) (Li-CMC:SBR=1:2 weight ratio), 2 wt % of Ag nanoparticles (D50: 60 nm), 40 wt % of carbon black, and 50 wt % of Nb₂O₅ were mixed in a water solvent to prepare a negative catalyst layer slurry.

Using the negative electrode, and the positive electrode and the solid electrolyte of Example 1, an all solid-state cell was fabricated by the same procedure as in Example 1.

### Comparative Example 4

A negative electrode was prepared by the same procedure as in Example 1, except that 8 wt % of a mixed binder of Li-carboxymethyl cellulose (Li-CMC) and a styrene butadiene rubber (SBR) (Li-CMC:SBR=1:2 weight ratio), 60 wt % of carbon black, and 32 wt % of Nb₂O₅ were mixed in a water solvent to prepare a negative catalyst layer slurry.

Using the negative electrode, the positive electrode, and the solid electrolyte of Example 1, an all solid-state cell was fabricated by the same procedure as in Example 1.

### Comparative Example 5

An all solid-state battery was fabricated by the same procedure as in Example 1, except that the negative electrode of Example 1 was used and a loading level was controlled in order to a N/P ratio of 0.09.

Using the negative electrode, the positive electrode, and the solid electrolyte of Example 1, an all solid-state cell was fabricated by the same procedure as in Example 1.

### Comparative Example 6

An all solid-state battery was fabricated by the same procedure as in Example 1, except that the negative electrode of Example 1 was used and a loading level was controlled in order to a N/P ratio of 0.5.

### Comparative Example 7

An all solid-state battery was fabricated by the same procedure as in Example 1, except that the negative electrode of Example 6 was used and a loading level was controlled in order to a N/P ratio of 0.09.

### Comparative Example 8

An all solid-state battery was fabricated by the same procedure as in Example 1, except that the negative electrode of Example 6 was used and a loading level was controlled in order to a N/P ratio of 0.5.

### Experimental Example 1) Measurement of Electrical Resistance

The electrical resistances (sheet resistance) of the negative electrodes according to Examples 1 to 8 and Comparative Examples 1 to 8 were probed with 46 pins via a 4-probe procedure (XF057, available from HIOKI, Co., Ltd.). The results are shown in Table 2.

### Experimental Example 2) Measurement Surface Roughness

The surface roughness (Ra) of the negative electrodes according to Examples 1 to 8 and Comparative Examples 1 to 8 were measured. The results are shown in Table 2. The surface roughness is an average value obtained by summing absolute values of deviations from the reference surface to the measured surface, and i.e., values obtained by calculating the average of the absolute value of the differences between all points on the surface to the reference surface. The surface roughness was measured by using a 3D optical microscope (optical microscopy, available from Keyence, Co., Ltd.).

### Experimental Example 3) Evaluation of Overvoltage

The all solid-state cells of Examples 1 to 8 and Comparative Examples 1 to 8 were charged at 0.05 C and the voltage drop started at OCV (open circuit voltage, about 2.5 V). Thereafter, the voltage up to the point where an inflection point occurred at around about 0 mV was measured. The results are shown in Table 2, as overvoltage.

### Experimental Example 4) Evaluation of Initial Efficiency

The all solid-state cells of Examples 1 to 8 and Comparative Examples 1 to 8 were charged and discharged at 0.05 C once to obtain a percentage value of discharge capacity to charge capacity. The results are shown in Table 2, as an initial efficiency.

### Experimental Example 5) Evaluation of Power Efficiency

The all solid-state cells of Examples 1 to 6 and Comparative Examples 1 to 4 were charged at 0.05 C and discharged at 0.1 C. The percentage value of the discharge capacity to the charge capacity was measured. The results are shown in Table 2, as power efficiency.

The composition of the negative catalyst layers of Examples 1 to 8 and Comparative Examples 1 to 4 are summarized in Table 1.

The N/P ratios of the all solid-state cells are shown in Table 1. The N/P ratio was obtained from a ratio of a capacity of the negative catalyst layer relative to a capacity (theoretical capacity) of the positive electrode. The theoretical capacity of the negative catalyst layer was obtained by charging a half-cell at 0.05 C once and measuring a capacity to the inflection point near 0 mV (vs. Li). The half-cell was fabricated by using the solid electrolytes and the negative electrodes of Examples 1 to 8 and Comparative Examples 1 to 8, and a lithium counter electrode.

TABLE 1

| | Binder | Carbon black | Ag | Nb₂O₅ | N/P |
|---|---|---|---|---|---|
| | (wt %) | (wt %) | (wt %) | (wt %) | ratio |
| Example 1 | 8 | 86 | 5 | 1 | 0.15 |
| Example 2 | 8 | 85 | 4 | 3 | 0.14 |
| Example 3 | 8 | 83 | 4 | 5 | 0.16 |
| Example 4 | 8 | 78 | 4 | 10 | 0.17 |
| Example 5 | 8 | 64 | 3 | 25 | 0.12 |
| Example 6 | 8 | 59 | 3 | 30 | 0.12 |
| Example 7 | 8 | 82 | 0 | 10 | 0.12 |
| Example 8 | 8 | 62 | 0 | 30 | 0.11 |
| Comparative | 8 | 87 | 4.2 | 0.8 | 0.15 |
| Example 1 | | | | | |
| Comparative | 8 | 57 | 3 | 32 | 0.13 |
| Example 2 | | | | | |
| Comparative | 8 | 40 | 2 | 50 | 0.12 |
| Example 3 | | | | | |
| Comparative | 8 | 60 | 0 | 32 | 0.12 |
| Example 4 | | | | | |
| Comparative | 8 | 86 | 5 | 1 | 0.09 |
| Example 5 | | | | | |
| Comparative | 8 | 86 | 5 | 1 | 0.5 |
| Example 6 | | | | | |
| Comparative | 8 | 59 | 3 | 30 | 0.09 |
| Example 7 | | | | | |
| Comparative | 8 | 59 | 3 | 30 | 0.5 |
| Example 8 | | | | | |

TABLE 2

| | Electrode characteristic | | Electrochemical performance | | |
|---|---|---|---|---|---|
| | Electrical | Surface | Over- | Initial | Power |
| | resistance | roughness | voltage | efficiency | efficiency |
| | (10⁻² Ωcm) | (μm) | (mV) | (%) | (%) |
| Example 1 | 5.11 | 0.30 | 14.2 | 86.3 | 94.4 |
| Example 2 | 5.14 | 0.30 | 14.2 | 86.2 | 94.2 |
| Example 3 | 5.23 | 0.32 | 13.7 | 88.7 | 94.8 |
| Example 4 | 5.42 | 0.36 | 13.3 | 88.2 | 96.5 |
| Example 5 | 6.03 | 0.45 | 13.8 | 88.3 | 96.5 |
| Example 6 | 6.21 | 0.44 | 13.8 | 86.6 | 94.9 |
| Example 7 | 5.63 | 0.37 | 14.8 | 88.0 | 95.8 |
| Example 8 | 6.25 | 0.48 | 15.8 | 86.0 | 94.2 |
| Comparative | 5.10 | 0.29 | 14.3 | 85.9 | Short- |
| Example 1 | | | | | circuit |
| Comparative | 6.50 | 0.52 | 15.6 | 84.2 | Short- |
| Example 2 | | | | | circuit |
| Comparative | 7.10 | 0.59 | 18.6 | 83.1 | Short- |
| Example 3 | | | | | circuit |
| Comparative | 6.58 | 0.53 | 16.5 | 83.9 | Short- |
| Example 4 | | | | | circuit |
| Comparative | 5.33 | 0.42 | 13.5 | 85.9 | 87.9 |
| Example 5 | | | | | |
| Comparative | —(Unmea- | 0.89 | 20.1 | 52.3 | Short- |
| Example 6 | surable) | | | | circuit |
| Comparative | 6.06 | 0.44 | 14.9 | 84.7 | 87.2 |
| Example 7 | | | | | |
| Comparative | —(Unmea- | 0.99 | 24.0 | 57.8 | Short- |
| Example 8 | surable) | | | | circuit |

As shown in Table 2, Examples 1 to 8 in which the negative catalyst layer included Nb₂O₅ at 1 wt % to 30 wt %, and the N/P ratio was 0.1 or more, and less than 0.5 exhibited low electrical resistance and surface roughness, low overvoltage, and excellent initial efficiency and power efficiency.

On the other hand, in case of Comparative example 1 including a very small amount of Nb₂O₅, initial efficiency was deteriorated and a short-circuit occurred.

Comparative Example 2 using Nb₂O₅ at 32 wt % exhibited an increased electrical resistance and surface roughness, increases in overvoltage, and deteriorated initial efficiency. In case of Comparative Example 3 if an excessive amount of Nb₂O₅ at a 50 wt % was used, the electrical resistance and surface roughness were significantly increased, the initial efficiency was greatly deteriorated, and a short-circuit occurred. Comparative Example 4 using no Ag exhibited high battery resistance, surface roughness, low overvoltage, low initial efficiency, and a short-circuit.

Even if in Comparative Examples 5 and 7 having the N/P ratio of less than 0.1, and Nb₂O₅ was used at an amount of 1 wt % and 30 wt %, slightly low initial efficiency and the deteriorated power efficiency were exhibited. Even if in Comparative Examples 6 and 8 having the N/P ratio of 0.5 or more, Nb₂O₅ was used at an amount of 1 wt % and 30 wt %, the resistance was too high to be measurable, the extreme deteriorated initial efficiency was exhibited, and a short-circuit occurred.

### Experimental Example 6) SEM Image and EDAX

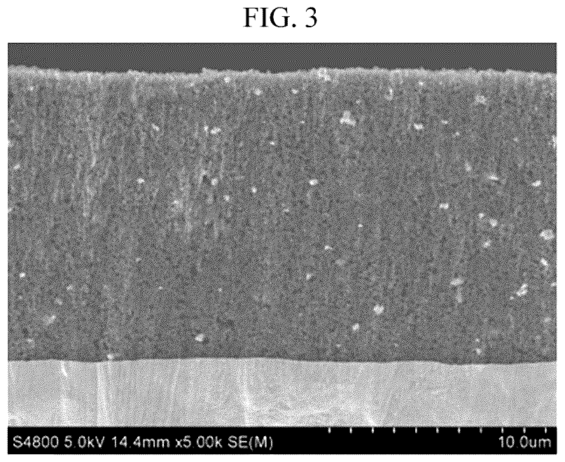

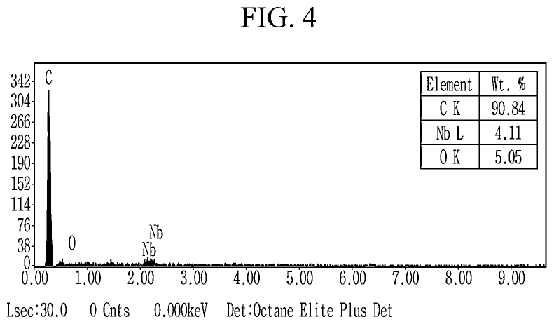

The negative electrode according to Example 1 was cross-polished to flatten one surface thereof. The surface SEM image for the obtained negative electrode is shown in FIG. 3. The EDAX result for the negative electrode is shown in FIG. 4.

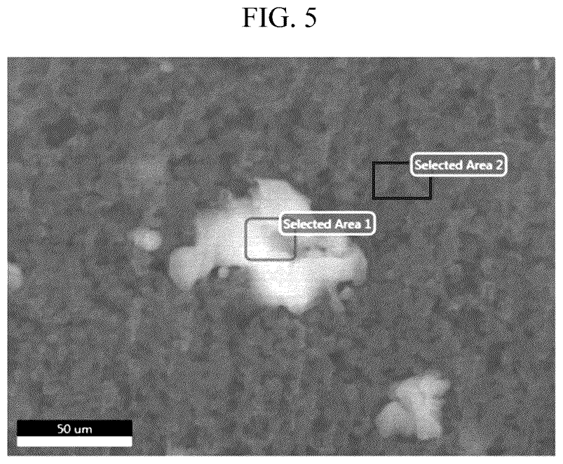

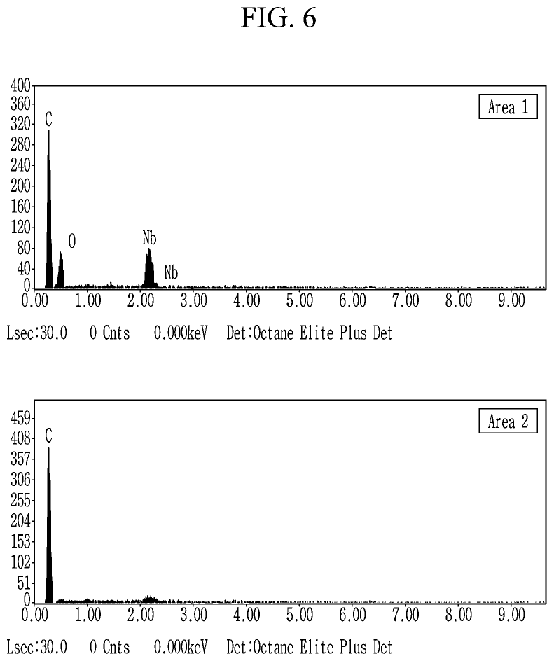

The SEM image from FIG. 3 has been enlarged 20,000 times and is shown in FIG. 5. The EDAX results for the selected area 1 and the selected area 2 in FIG. 5 were shown in FIG. 6.

From the EDAX results of FIG. 4, it may be seen that Nb₂O₅ was present on the negative electrode of Example 1.

In the SEM image shown in FIG. 3, the bright colored dot indicated as Nb₂O₅, which was clearly shown from FIG. 6 showing the EDAX results in which the presence of C, O, and Nb peaks was in the selected area 1 of FIG. 5, while the only C peak was in the selected area 2 of FIG. 5.

By way of summation and review, embodiments may provide an all solid-state battery exhibiting excellent electrochemical performances.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. An all solid-state battery, comprising:
a positive electrode comprising a positive active material layer including a positive active material;
a negative catalyst layer including a negative catalyst and Nb₂O₅; and
an electrolyte layer,
wherein an amount of Nb₂O₅ is about 1 wt % to about 30 wt % based on 100 wt % of the negative catalyst layer, and
wherein a ratio (N/P) of a capacity of the negative catalyst layer relative to a capacity of the positive electrode is about 0.1 or more and less than about 0.5.

2. The all solid-state battery as claimed in claim 1, wherein the amount of Nb₂O₅ is about 3 wt % to about 30 wt % based on the total, 100 wt % of the negative catalyst layer.

3. The all solid-state battery as claimed in claim 1, wherein the amount of Nb₂O₅ is about 5 wt % to about 15 wt % based on the total, 100 wt % of the negative catalyst layer.

4. The all solid-state battery as claimed in claim 1, wherein the ratio (N/P) of the capacity of the negative catalyst layer relative to the capacity of the positive electrode is about 0.1 to about 0.4.

5. The all solid-state battery as claimed in claim 1, wherein the ratio (N/P) of the capacity of the negative catalyst layer relative to the capacity of the positive electrode is about 0.1 to about 0.3.

6. The all solid-state battery as claimed in claim 1, wherein the negative catalyst is a carbon-based material, metal particles, or combinations thereof.

7. The all solid-state battery as claimed in claim 6, wherein the carbon-based material is an amorphous carbon.

8. The all solid-state battery as claimed in claim 6, wherein the metal particles comprise at least one selected from Ag, Zn, Al, Sn, Mg, Ge, Cu, In, Ni, Bi, Au, Si, Pt, Pd, and combinations thereof.

9. The all solid-state battery as claimed in claim 1, wherein the electrolyte layer comprises a solid electrolyte.

10. The all solid-state battery as claimed in claim 9, wherein the solid electrolyte is a sulfide-based solid electrolyte, an oxide-based solid electrolyte, a halide-based solid electrolyte, or a solid polymer electrolyte.

11. The all solid-state battery as claimed in claim 1, wherein the negative electrode further comprises a current collector supporting the negative catalyst layer, and
a lithium deposition layer formed between the current collector and the negative catalyst layer during an initial charging.

12. The all solid-state battery as claimed in claim 1, wherein the positive active material is an active material being capable of reversibly intercalating and deintercalating lithium ions or a sulfur-based compound.

13. The all solid-state battery as claimed in claim 12, wherein
the positive active material is the active material being capable of reversibly intercalating and deintercalating lithium ions.
